(19) United States
(12) Patent Application Publication
(10) Pub. No.: US 2017/0358971 A1
(43) Pub. Date: Dec. 14, 2017

(54) RENEWABLE ENERGY CYCLE SYSTEM AND METHOD THEREOF

(71) Applicant: Sheng-Chung CHAO, Taoyuan City (TW)

(72) Inventor: Sheng-Chung CHAO, Taoyuan City (TW)

(21) Appl. No.: 15/177,238

(22) Filed: Jun. 8, 2016

(51) Int. Cl. H02K 7/18; F01K 13/02; F03G 7/10

(52) U.S. Cl. CPC H02K 7/1815; F01K 13/02; Y10S 74/09; F03G 7/10

(57) ABSTRACT

A renewable energy cycle system and method thereof is disclosed, wherein the renewable energy cycle system comprises a water softening equipment, an electrolysis hydrogen equipment, at least a combustion boiler equipment, a generator and at least a steam efficacy conversion device. Herein softened water can be electrolyzed into hydrogen and oxygen by means of the electrolysis hydrogen equipment, and the decomposed hydrogen can be transported to the combustion boiler equipment for combustion such that the liquid in the combustion boiler equipment boils and generates saturated vapor pressure. Next, the generated saturated vapor pressure can be outputted into the steam efficacy conversion equipment such that the steam efficacy conversion equipment can convert the steam efficacy into mechanical energy thereby allowing the steam engine in the steam efficacy conversion equipment to rotate in high speed. Then, the generated high speed rotations can draw the generator to cut the internal magnetic lines to perform mechanical operations for power generation, and the electric energy created by the mechanical operations of power generation can be circularly provided to the electrolysis hydrogen equipment as the required electric power for operations thereof so as to achieve the objective of environment protective cycle power supply.

### BACKGROUND OF THE INVENTION

### 1. Field of the Invention

The present invention generally relates to a renewable energy cycle system and method thereof; in particular, it concerns a system capable of circularly converting the steam efficacy into mechanical energy and the method thereof.

### 2. Description of Related Art

It is well-known that currently available approaches for power generation include hydropower, thermal power or nuclear power etc. Among such, the hydropower essentially applies water level differences to convert into electricity, which requires a huge amount of water sources and in general is constructed simply in accordance with local environment, thus significantly restricted by many geographical factors. Meanwhile, the thermal power relies on fuels such as coals, petroleum, natural gases or the like, characterized in comparatively higher production costs and potentially greater damages to the environment; moreover, although the nuclear power may seem to be more economical at a first glance, lots of adverse influences which may jeopardize the Earth in other aspects can be far more profound and serous. Especially, in case of grave incidents, the consequences thereof may be catastrophic as well.

Additionally, in history, people living in the days of industrial revolution had already started to research and develop the applications of steam for generating drive force to operate machines, and the concept that large power can be generated by means of steam was comprehensively understood. However, vapor may disappear quickly; hence, with all the aged and conventional technologies at that time, the applications of steam were certainly limited to a significant extent; but, from the view of modern technologies, effective circle utilization may be successfully achieved suppose it is possible to create steam to generate electric power and then use the generated electric power back to create steam in a circular and continuous fashion.

At present, the energy issue has been one of the major and hot topics, and the energy-saving feature allows to reduce pollutions to our environment thus becoming a critical direction for future energy development. Therefore, the present invention may provide an optimal solution to such issues by using saturated vapor pressure to drive rotations, then applying the created high speed rotations to draw a generator so as to cut internal magnetic lines to perform mechanical operations for power generation, and further utilizing the generated electricity to circularly supply electric power for creating saturated vapor pressure, thus repeatedly running to achieve the objective of environment protective circle power supply.

### SUMMARY OF THE INVENTION

The present invention relates to a renewable energy cycle system and method thereof, in which softened water can be electrolyzed to release hydrogen for combustion in order to boil the liquid within the combustion boiler equipment to generate saturated vapor pressure, and the generated saturated vapor pressure can drive the engine to rotate such that the resulted high speed rotations can draw the generator to cut internal magnetic lines to perform mechanical operations for power generation, and the generated electric energy can be further circularly supplied to generate the saturated vapor pressure thereby achieving the objective of environment protective circle power supply.

A renewable energy cycle system according to the present invention comprises an electricity supply equipment, used for supplying the required electric power for the initial operation of the renewable energy cycle system; a water softening equipment, used for offering the softened water output; an electrolysis hydrogen equipment, connected to the water softening equipment thereby electrolyzing the softened water outputted by the water softening equipment into hydrogen and oxygen; at least a combustion boiler equipment, including at least a boiler and at least a combustion device, wherein the hydrogen coming from the decomposition of softened water electrolyzed by the electrolysis hydrogen equipment can be transported into the combustion device for combustion in order to generate thermal energy such that the liquid in the boiler can be boiled to generate saturated vapor pressure; a generator, which may be a mechanical power generation device capable of performing mechanical operations for power generation, in which the electric energy generated by the generator can be transported to the water softening equipment and the electrolysis hydrogen equipment so as to supply the required electric power for the operations of the water softening equipment and the electrolysis hydrogen equipment; at least a steam efficacy conversion equipment, connected to the combustion boiler equipment and the generator and used to convert the steam efficacy into mechanical energy, in which the inside of the steam efficacy conversion equipment includes at least a steam engine and a linkage drive device connected to the steam engine and the generator, wherein the saturated vapor pressure created by the liquid in the boiler of the combustion boiler equipment can bring the steam engine to rotate such that the high speed rotations generated by the steam engine can further draw the generator by way of the linkage drive device in order to cut the magnetic lines within the generator thereby performing mechanical operations for power generation.

More specifically, the power supply equipment is an alternative current/direct current (AC/DC) conversion device, and the AC/DC conversion device can be electrically connected to a power grid end so as to convert the AC power supplied by the power grid end into DC power thereby providing the required power for the initial operation of the renewable energy cycle system.

More specifically, the renewable energy cycle system further comprises a power storage equipment electrically connected to the generator thereby storing the electric power created by the mechanical power generation with the power storage equipment.

More specifically, the renewable energy cycle system further comprises a boiler water feed connected to the boiler of the combustion boiler equipment so as to supply the liquid required for the boiling effect in the boiler.

More specifically, the renewable energy cycle system further comprises a steam recovery equipment connected to the steam efficacy conversion equipment to recover the steam within the steam efficacy conversion equipment.

More specifically, the renewable energy cycle system further comprises a cooling device to reduce the thermal energy generated during the operation of the electrolysis hydrogen equipment.

More specifically, in the renewable energy cycle system, the steam efficacy conversion equipment is a steam engine or a turbine.

More specifically, the renewable energy cycle system further comprises a fuel input equipment connected to the electrolysis hydrogen equipment and the combustion device, in which the fuel input equipment is used to mix the hydrogen decomposed from the electrolysis hydrogen equipment and biomass fuels and then output into the combustion device for combustion thereby generating thermal energy.

A renewable energy cycle method comprises:

(1) electrolyzing softened water into hydrogen and oxygen by means of an electrolysis hydrogen equipment;

(2) transporting the decomposed hydrogen into a combustion boiler equipment for combustion such that the liquid within the combustion boiler equipment can boil to generate saturated vapor pressure;

(3) outputting the generated saturated vapor pressure into a steam efficacy conversion equipment having a steam engine and connected to a generator thus allowing the steam efficacy conversion equipment to convert the steam efficacy into mechanical energy such that the steam engine can operate in high speed rotations, and the created high speed rotations can further draw the generator to cut the internal magnetic lines thereby performing mechanical operations for power generation;

(4) circularly supplying the electric energy generated by the mechanical operations of power generation to the electrolysis hydrogen equipment as the required power in order to execute the circular power supply during the power generation processes.

More specifically, the electric power required for the initial operation of the electrolysis hydrogen equipment is externally provided, and after the generator is able to perform mechanical operations of power generation and circularly supply to the electrolysis hydrogen equipment, external electric power is no longer needed.

More specifically, the greater the created saturated vapor pressure is, the faster the rotation speed of the steam engine becomes, thus correspondingly obtaining the higher power generation efficiency of the mechanical operations in the generator.

### BRIEF DESCRIPTION OF THE DRAWINGS

FIG. 1 shows an overall architecture diagram for the renewable energy cycle system and method thereof according to the present invention.

FIG. 2 shows a flowchart for the renewable energy cycle system and method thereof according to the present invention.

### DETAILED DESCRIPTION OF THE PREFERRED EMBODIMENTS

Other technical contents, aspects and effects in relation to the present invention can be clearly appreciated through the detailed descriptions concerning the preferred embodiments of the present invention in conjunction with the appended drawings.

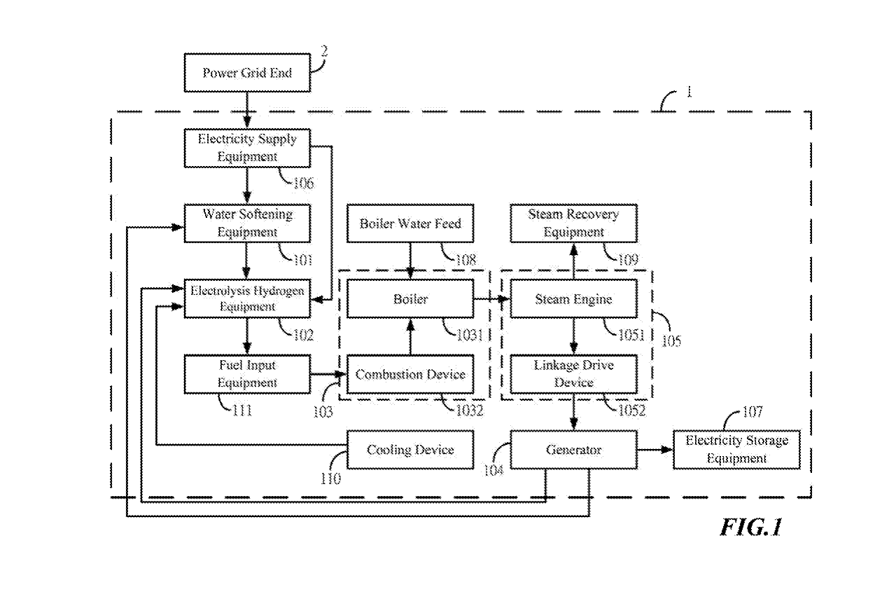

Refer first to FIG. 1, wherein an overall architecture diagram for the renewable energy cycle system and method thereof according to the present invention is shown, and it can be appreciated from the Figure that the renewable energy cycle system 1 comprises a water softening equipment 101, at least an electrolysis hydrogen equipment 102, at least a combustion boiler equipment 103, a generator 104, at least a steam efficacy conversion device 105, a power supply equipment 106, a power storage equipment 107, a boiler water feed 108, a steam recovery equipment 109, a cooling device 110 and a fuel input equipment 111.

Herein the water softening equipment 101 can be used to supply softened water for output to the electrolysis hydrogen equipment 102, the electrolysis hydrogen equipment 102 can operate to electrolyze the softened water coming from the water softening equipment 101 into hydrogen and oxygen, and the combustion boiler equipment 103 includes as least a boiler 1031 and at least a combustion device 1032. Moreover, the fuel input equipment 111 mixes the hydrogen decomposed from the electrolysis hydrogen equipment with biomass fuels, then outputs into the combustion device 1032 for combustion thereby generating thermal energy, in which the biomass fuels may be fuels capable of preventing excessively fast volatilization of hydrogen (e.g., cleaning naphtha oil.)

In addition, the liquid within the boiler 1031 is supplied by the boiler water feed 108, and since the combustion device 1032 allows to combust in order to generate thermal energy, the liquid within the boiler 1031 can boiled to create the intended saturated vapor pressure (however, high pressure vapor or low pressure vapor may be formed in the saturated vapor pressure based on the heated temperature, so different conversions can obtain different effects); hence, in a preferred embodiment, the liquid provided by the boiler water feed 108 is softened water such that the liquid impurities within the boiler 1031 can be reduced to the least.

Also, the steam efficacy conversion equipment 105 may be a steam engine or a turbine (i.e., seeing that the turbine can receive higher amount of steam than the steam engine, in case the amount of input steam is sufficiently large, it is possible to apply the turbine), mainly utilized to convert the steam efficacy into mechanical energy. Furthermore, the inside of the steam efficacy conversion equipment 105 includes at least a steam engine 1051 and a linkage drive device 1052 connected to the steam engine 1051, in which the saturated vapor pressure created by the liquid within the boiler 1031 can push the steam engine 1051 to rotate (herein the steam engine 1051 may be installed with a windmill-like device, based on various implementations.) Also, since the linkage drive device 1052 in the present embodiment is exemplified as a belt (other devices enabling equivalent functions may be used in accordance with actual implementations) and connected to the steam engine 1051 as well as the mechanic equipment on the generator 104, when the steam engine 1051 operates in high speed rotations, it is possible to draw the generator 104 by means of the linkage drive device 1052 to cut internal magnetic lines of the generator 104 in order to perform mechanical operations for power generation.

The electric energy generated by the generator 104 can be transferred to the water softening equipment 101, the electrolysis hydrogen equipment 102 and other devices or equipments in order to provide electric power required for their operations, but, since the water softening equipment 101 and the electrolysis hydrogen equipment 102 are unable to run before the generator 104 successfully generates electric energy, it is necessary to supply electric power needed for their initial operations via the power supply equipment 106. In the present embodiment, the power supply equipment 106 is illustrated as an alternative current/direct current (AC/DC) conversion device which is electrically connected to a power grid end 2, so the AC power supplied by the power grid end 2 can be converted into DC power and then transferred to the water softening equipment 101 and the electrolysis hydrogen equipment 102 in order to start their initial executions. Then, after the generator 104 successfully generates electric energy, the power grid end 2 is no longer needed to provide the required electric power to the water softening equipment 101, the electrolysis hydrogen equipment 102 and other devices or equipments.

Besides, the power supply equipment 106 may be also a battery or other types of apparatus capable of supplying electric power required for the initial operations, hence by no means limited to the aforementioned AC/DC conversion device.

Moreover, in addition to transferring the electric energy generated by the generator 104 to the renewable energy cycle system 1 as its required electric power, the remained portion of such generated electric energy can be also further saved in the power storage equipment 107 for miscellaneous applications.

Furthermore, the steam capacity conversion equipment 105 can be further connected to the steam recovery equipment 109 thereby restoring remained steam within the steam capacity conversion equipment for cooling in order to facilitate reuse (herein the “reuse” may indicate that the additional steam can be injected into another steam capacity conversion equipment 105, or otherwise turned back to water and sent into the boiler water feed 108 once again to supply the required liquid in the boiler 1031.)

Also, high temperature may occur when the electrolysis hydrogen equipment 102 electrolyzes the softened water coming from the water softening equipment 101 into hydrogen and oxygen, it is required to utilize the cooling device 110 to bring down the temperature of the electrolysis hydrogen equipment 102 thus reducing the thermal energy created during the operation of the electrolysis hydrogen equipment 102.

The practice of the present invention can be briefly illustrated as below:

(1) in case the power grid end 2 supplies electric power of 3˜4 horsepower (hp), the power supply equipment 106 converts AC power provided by the power grid end 2 into DC power;

(2) afterwards, the water softening equipment 101 processes water into softened water and outputs to an electrolysis tank within the electrolysis hydrogen equipment 102 such that the electrolysis hydrogen equipment 102 electrolyzes the softened water in the electrolysis tank into hydrogen and oxygen, and the hydrogen decomposed in the electrolysis hydrogen equipment can be mixed with biomass fuels through the fuel input equipment 111 and then transferred into the combustion device 1032 so as to generate thermal energy of approximately 6000˜8000 Kcal for combustion;

(3) the inside of the boiler 1031 holds softened water of a volume of roughly 2000 CC, in which this “2000 CC” indicates a basic water level in the boiler 1031 and acts as a basis for saturated vapor, but the basic water level may vary in accordance with different sizes of the boiler 1031;

(4) the combustion device 1032 provides an amount of average heat enabling elevation of 1° C. per minute in average, so the temperature of the softened water within the boiler 1031 can gradually rise up thus creating the saturated vapor pressure of 10˜12 Kg upon reaching 180° C.;

(5) next, the saturated vapor pressure created within the boiler 1031 can drive the steam engine 1051 to rotate to a speed of 800˜1000 rotations per minute, and the greater the saturated vapor pressure is, the higher the rotation speed becomes, thus correspondingly converting more mechanic energy, such that the linkage drive device 1052 can draw the generator 104 to operate thereby cutting internal magnetic line of the generator 104 with the above-said rotation speed to perform mechanic operations for power generation; also, from in-situ practice records, when the power grid end 2 provides electric power of 3˜4 hp, the electricity generated by the generator 104 may be about 10 KW, so it is possible to transfer a portion of it (e.g., circa 3 KW) back to the renewable energy cycle system 1 as required power for operations, while the remained power of 7 KW can be saved in the power storage equipment 107 for miscellaneous applications;

(6) seeing that the electric power of 3˜4 hp was inputted at first in the present invention, but the generated electric power in the end can be roughly 10 KW, it can be appreciated that the present invention obviously enables an effect of power amplification, thus allowing the maximal and the most efficient utilization of energy through the system and method according to the present invention.

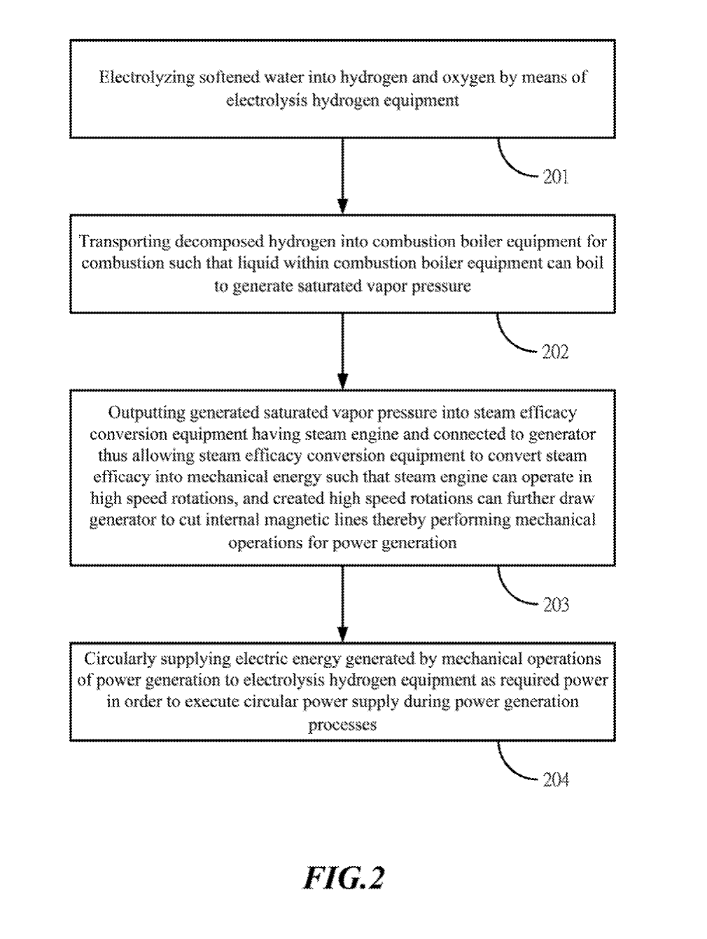

Next, a flowchart for the renewable energy cycle method according to the present invention is shown in FIG. 2, comprising:

(1) electrolyzing softened water into hydrogen and oxygen by means of an electrolysis hydrogen equipment (201);

(2) transporting the decomposed hydrogen into a combustion boiler equipment for combustion such that the liquid within the combustion boiler equipment can boil to generate saturated vapor pressure (202);

(3) outputting the generated saturated vapor pressure into a steam efficacy conversion equipment having a steam engine and connected to a generator thus allowing the steam efficacy conversion equipment to convert the steam efficacy into mechanical energy such that the steam engine can operate in high speed rotations, and the created high speed rotations can further draw the generator to cut the internal magnetic lines thereby performing mechanical operations for power generation (203);

(4) circularly supplying the electric energy generated by the mechanical operations of power generation to the electrolysis hydrogen equipment as the required power in order to execute the circular power supply during the power generation processes (204).

In comparison with other conventional technologies, the renewable energy cycle system and method thereof according to the present invention provides the following advantages:

(1) Softened water can be electrolyzed to release hydrogen for combustion in order to boil the liquid within the combustion boiler equipment to generate saturated vapor pressure, and the generated saturated vapor pressure can drive the engine to rotate such that the resulted high speed rotations can draw the generator to cut internal magnetic lines to perform mechanical operations for power generation, and the generated electric energy can be further circularly supplied to generate the saturated vapor pressure thereby achieving the objective of environment protective circle power supply.

(2) The feature of energy-saving can be effectively achieved during the power generation process of the present invention to reduce pollutions to the environment, thus standing for an environment protective, green energy generation technology.

It should be noticed that, although the present invention has been disclosed through the detailed descriptions of the aforementioned embodiments, such illustrations are by no means used to restrict the present invention; that is, skilled ones in relevant fields of the present invention can certainly devise any applicable alternations and modifications after having comprehended the aforementioned technical characteristics and embodiments of the present invention without departing from the spirit and scope thereof. Hence, the scope of the present invention to be protected under patent laws should be delineated in accordance with the claims set forth hereunder in the present specification.

What is claimed is:

1. A renewable energy cycle system comprises:
an electricity supply equipment, used for supplying the required electric power for the initial operation of the renewable energy cycle system;
a water softening equipment, used for offering the softened water output;
at least an electrolysis hydrogen equipment, connected to the water softening equipment thereby electrolyzing the softened water outputted by the water softening equipment into hydrogen and oxygen;
at least a combustion boiler equipment, including at least a boiler and at least a combustion device, wherein the hydrogen coming from the decomposition of softened water electrolyzed by the electrolysis hydrogen equipment can be transported into the combustion device for combustion in order to generate thermal energy such that the liquid in the boiler can be boiled to generate saturated vapor pressure;
a generator, which may be a mechanical power generation device capable of performing mechanical operations for power generation, in which the electric energy generated by the generator can be transported to the water softening equipment and the electrolysis hydrogen equipment so as to supply the required electric power for the operations of the water softening equipment and the electrolysis hydrogen equipment;
at least a steam efficacy conversion equipment, connected to the combustion boiler equipment and the generator and used to convert the steam efficacy into mechanical energy, in which the inside of the steam efficacy conversion equipment includes at least a steam engine and a linkage drive device connected to the steam engine and the generator, wherein the saturated vapor pressure created by the liquid in the boiler of the combustion boiler equipment can bring the steam engine to rotate such that the high speed rotations generated by the steam engine can further draw the generator by way of the linkage drive device in order to cut the magnetic lines within the generator thereby performing mechanical operations for power generation.

2. The renewable energy cycle system according to claim 1, wherein the power supply equipment is an alternative current/direct current (AC/DC) conversion device, and the AC/DC conversion device can be electrically connected to a power grid end so as to convert the AC power supplied by the power grid end into DC power thereby providing the required power for the initial operation of the renewable energy cycle system.

3. The renewable energy cycle system according to claim 1, further comprising a power storage equipment electrically connected to the generator thereby storing the electric power created by the mechanical power generation with the power storage equipment.

4. The renewable energy cycle system according to claim 1, further comprising a boiler water feed connected to the boiler of the combustion boiler equipment so as to supply the liquid required for the boiling effect in the boiler.

5. The renewable energy cycle system according to claim 1, further comprising a steam recovery equipment connected to the steam efficacy conversion equipment to recover the steam within the steam efficacy conversion equipment.

6. The renewable energy cycle system according to claim 1, further comprising a cooling device to reduce the thermal energy generated during the operation of the electrolysis hydrogen equipment.

7. The renewable energy cycle system according to claim 1, wherein the steam efficacy conversion equipment is a steam engine or a turbine.

8. The renewable energy cycle system according to claim 1, further comprising a fuel input equipment connected to the electrolysis hydrogen equipment and the combustion device, in which the fuel input equipment is used to mix the hydrogen decomposed from the electrolysis hydrogen equipment with biomass fuels and then output into the combustion device for combustion thereby generating thermal energy.

9. A renewable energy cycle method comprises:
electrolyzing softened water into hydrogen and oxygen by means of an electrolysis hydrogen equipment;
transporting the decomposed hydrogen into a combustion boiler equipment for combustion such that the liquid within the combustion boiler equipment can boil to generate saturated vapor pressure;
outputting the generated saturated vapor pressure into a steam efficacy conversion equipment having a steam engine and connected to a generator thus allowing the steam efficacy conversion equipment to convert the steam efficacy into mechanical energy such that the steam engine can operate in high speed rotations, and the created high speed rotations can further draw the generator to cut the internal magnetic lines thereby performing mechanical operations for power generation;
circularly supplying the electric energy generated by the mechanical operations of power generation to the electrolysis hydrogen equipment as the required power in order to execute the circular power supply during the power generation processes.

10. The renewable energy cycle method according to claim 9, wherein the electric power required for the initial operation of the electrolysis hydrogen equipment is externally provided, and after the generator is able to perform mechanical operations of power generation and circularly supply to the electrolysis hydrogen equipment, external electric power is no longer needed.

11. The renewable energy cycle method according to claim 9, wherein the greater the created saturated vapor pressure is, the faster the rotation speed of the steam engine becomes, thus resulting in higher power generation efficiency of the mechanical operations in the generator.
